(19) United States
(12) Patent Application Publication
(10) Pub. No.: US 2005/0222284 A1
(43) Pub. Date: Oct. 6, 2005

(54) Synergistic flame retardant blends for polyurethane foams

(76) Inventors: Barbara A. Williams, New York, NY (US); Danielle Angrand Bright, New City, NY (US); Emanuel Pinzoni, Hawthorne, NJ (US); Theodore Halchak, Upper Montclair, NJ (US)

Correspondence Address: DILWORTH & BARRESE, LLP, 333 EARLE OVINGTON BLVD., UNIONDALE, NY, 11553, US

(21) Appl. No.: 10/513,744

(22) PCT Filed: May 6, 2003
(86) PCT No.: PCT/US03/14145

§ 371 Date: May 20, 2005

(30) Foreign Application Priority Data
May 7, 2002 (US) 60378482

(51) Int. Cl. C08K 3/00

(52) U.S. Cl. 521/82

(57) ABSTRACT

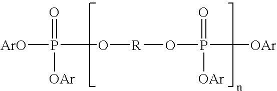

Flame-retardant blends are described that comprise: (a) a monomeric halogenated organic flame-retardant, which is adapted for use in a polyurethane foam formulation; and (b) an organic phosphate flame-retardant. The organic phosphate flame-retardant has the formula: where Ar is an aryl or an alkaryl group, R represents an alkylene or arylene group, and the average value of n is 0 to 5. In addition, an organic brominated additive can be selected in combination with the phosphate ester. These flame-retardants are incorporated into flexible polyurethane foams at various densities.

Various prior art disclosures exist in regard to flame retardant additives for polymers, such as polyurethane foams. Three representative examples of disclosures of this type, which relate to blends of two differing flame retardant additives, include the following:

U.S. Pat. No. 4,273,881 to J. G. Otten describes the use of a 50:50 mixture of flame retardant A, sold under the trademark ANTIBLAZE 19, and of bis-(2-chloroethyl)-2-chloroethyl-phosphonate (See Col. 9, lines 61-62).

U.S. Pat. No. 3,956,200 to J. Biranowski describes the use of flame retardant blends comprising a reactive polyglycol hydrogen polyphosphonate and an additive, non-reactive flame retardant in a ratio of from about 20:1 to 1:1, preferably from about 5:1 to 1:1.

U.S. Pat. No. 6,262,135 to L. Bradford describes the use of blends of a halogenated phosphate ester and an oligomeric organophosphorus flame-retardants. The halogenated phosphate ester is present at from about 60% to about 95%, by weight. The oligomeric component does not contain aromatic substituents.

In addition to the foregoing patent disclosures, certain blends of monomeric and oligomeric flame retardants have also been sold to the polyurethane industry, including compositions carrying the trademarks Fyrol® 25 and Fyrol® EFF of Akzo Nobel Funetional Chemicals. The product sold under the former mark contained an oligomer that comprised a blend of both phosphate and phosphonate moieties, whereas the product sold under the latter mark contained a major amount (about 66%) of the oligomeric component and a minor (about 32.5%) of the monomeric flame-retardant component. The Fyrol® EFF component does not contain aromatic substituents. These blends all contain halogen.

### THE INVENTION

The present invention relates to a flame-retardant blend comprising: (a) a monomeric halogenated organic flame-retardant that is adapted for use in polyurethane foam formulation; and (b) an organic phosphate flame-retardant. The organic phosphate flame-retardant has the formula: 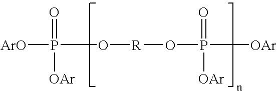
wherein Ar is an aryl or an alkaryl group, R represents an alkylene or arylene group and the average value of n is 0 to 5. In addition, an organic brominated additive can be selected in combination with the phosphate ester. These flame-retardants are incorporated into flexible polyurethane foams at various densities.

The fire retardants used by the flexible slab industry in the United States, for example, are primarily to meet two flammability tests. These are the MVSS302 test used by the automotive industry and the California Bureau of Home Furnishings 117A&D (the latter actually being a combination of two tests). This technology is currently dominated by two fire retardant chemicals: The first is tris dichloropropyl phosphate (TDCP) and is exemplified by Akzo Nobel's Fyrol® FR-2 brand product. The second is a blend of pentabromodiphenyl oxide and triaryl phosphates and is exemplified by Akzo Nobel's Fyrol® PBR brand product.

It is well known that high phosphorus-containing materials can be highly effective fire retardants (see U.S. Pat. No. 6,262,135). It is also well known that chlorinated phosphate esters are effective fire retardants in many polymeric systems such as flexible and rigid urethane foams. It is also not unexpected that when two effective fire retardants, as above, are blended the resulting blend will be less effective than the most effective of the two and more effective than the least effective of the two.

Extensive tests have shown that organic phosphates such as neopentyl glycol bis(diphenyl phosphate) or “NDP”, are in certain applications, just as efficient as the Fyrol®FR-2 or Fyrol® PBR brand products (see Tables 1 & 2, which follow). A blend of the two would be expected to perform well but non-synergistically.

An unexpected synergy applies to the MVSS302 test at 1.5 pounds per cubic foot (“pcf”) foam density. To pass this test, 14 parts of NDP and 15 parts of the Fyrol® FA-2 product are required. A 1:1 blend would theoretically pass at 14.50 parts. The actual passing level is 8 parts (see Table 1, which follows). From the attached data, it is clear that to achieve the optimum FR performance in varying densities, it is preferred to use varying blend levels to achieve optimum product and cost.

A second unexpected synergy is observed in the California TB 117* test. A 1.5 density foam requires 14 parts of NDP or 14-15 parts of PBR to pass this test. A 1:1 blend of NDP and FR-2 would theoretically pass at 14.50 parts ( 1/2a+ 1/2b). The actual passing level is only 8 parts.

### TYPICAL FORMULATION

The following flame retardant test data were generated using a typical polyether polyurethane flexible foam that was tested at nominal densities of 1.0, 1.5 and 1.8 pcf. The formulation used to make the foam was formed using a polyether polyol having a hydroxyl number of 56, a water level of from 3.55 to 5.6%, an amine level of about 0.25% and an NCO index of 110.

### TEST METHODS

The following standard tests were employed:

A. MVSS 302 Test: This test is a horizontal flame test that is used as a guideline for automobile manufactures. The sample size was 14″×4″×½″. There is a line 1½″ from the ignition point. A flame was ignited for fifteen seconds. The ignition source was then turned off, and the sample was rated. A “DNI” rating indicates that the sample did not support combustion (“did not ignite”). A rating of “SE” indicates that the sample ignited but did not burn to the timing zone, which is a point starting from the 1½″ mark to the 3½″ line. A rating of “SENBR” indicates that the sample burned past the 1½″ line but was extinguished before the 3½″ mark. A rating of “SE/B” indicates that a sample burned past the 3½″ mark but was extinguished before the endpoint. An ineh per minute rate was then calculated. The burn rate indicates that a sample burned passed the 3½″ mark. An indication of a burn rate or an SE/B rating that was higher than 4.0 in/min indicates failure in accordanee with this test. For this study a minimum performanee of SENBR was required.

B. Cal.TB 117 A Test: This test is a small-scale vertical test with a twelve-second-ignition time. The sample size was 12″×3×½″. The ignition source was removed after twelve seconds. A second clock is started if the sample continues to burn. The criteria for failing included: a sample exceeding an individual burn of eight inches or average burns of six inches. The time criteria required that an individual specimen would not have an individual afterflame or afterglow exceeding ten seconds or an average afterflame or afterglow exceeding five seconds.

C. Cal.TB 117 D Test: This test is a smoldering test in which a cigarette is used as the ignition source under a cotton cloth cover. The foam sample was covered with a standard velvet cotton cloth and was placed in a small wooden frame to form a mock chair. The back of the sample was 8″×7″×2″, and the seat was 8″×4″×2″. The sample was pre-weighed before testing and was again weighed after the test was finished. If the foam lost more than 20% of its weight, it was judged to be a failure.

A number of flame retardant additives were used in TB-117 and MVSS 302 tests in a variety of foams, either alone or in combination, as further described below. They were: tris(dichloropropyl) phosphate, available under the trademark FYROL® FR-2 from Akzo Nobel Chemicals Inc.; pentabromodiphenyloxide an additive that contains 75% of FYROL® PBR flame rtardant from Akzo Nobel Chemicals Inc.; neopentyl glycol bis(diphenyl phosphate), “NDP”; resorcinol bis(diphenyl phosphate), available under the trademark FYROLFLEX® RDP from Akzo Nobel; bisphenol A bis(diphenyl phosphate), available under the trademark FYROLFLEX® BDP, from Akzo Nobel; butylated triphenyl phosphate, available under the trademark PHOSFLEX® 71B, from Akzo Nobel; and isopropylated triphenyl phosphate, available under the trademark PHOSFLEX® 31L, also from Akzo Nobel.

Sinee the California 117 test requires passing two very different tests, the effect of each FR package on each test must be considered. For example, at low densities, it is easier to pass the smoldering test (Part D) and, at higher densities, it is easier to pass the flaming test (Part A)

The following data illustrates that relative performance of FR additives varies with foam densities as well as test method and that the described blends give unexpected synergism in some of these combinations (as density inereases, less FR additive is usually required to meet a specific test).

### RESULTS

### EXAMPLES 1- 16

### MVSS302 Automotive Test

In Table 1, the performanee of various neat flame-retardants and their blends with the Fyrol®FR-2 product is recorded. Also included in this table are the results of two blends of NDP with pentabromodiphenyl oxide @1:1 and 3:1 ratios. The following data illustrate the parts of flame-retardant needed to pass the MVSS302 automotive test in a 1.8 and 1.5 pcf density foams and the theoretical predicted amount:

TABLE 1
MVSS 302 Passing FR's levels

| | | MVSS302 | | MVSS302 | |
|---|---|---|---|---|---|
| | | Actual @ | Theoretical | Actual @ | Theoretical @ |
| Example | Flame Retardant | 1.8 pcf | 1.8 pcf | 1.5 pcf | 1.5 pcf |
| 1 | 100% NDP | 12 | 12 | 14 | 14 |
| 2 | 75% NDP:25% FR-2 | 10 | 11 | 12 | 14 |
| 3 | 50% NDP:50% FR-2 | 6 | 10 | 8 | 15 |
| 4 | 25% NDP:75% FR-2 | 8 | 8 | 10 | 15 |
| 5 | 100% Fyrol FR-2 | 7 | 7 | 15 | 15 |
| 6 | 100% RDP | 16 | 16 | 14 | 14 |
| 7 | 75% RDP:25% FR-2 | 10 | 14 | 14 | 14 |
| 8 | 100% BDP/31L* | 16 | 16 | >20 | Not available |
| 9 | 75% BDP/31L*:25% FR-2 | 10 | 14 | 20 | Not available |
| 10 | 25% Phos 71B:75% FR-2 | 12 | 9 | 8 | 14 |
| 11 | 50% Phos 71B:50% FR-2 | 12 | 12 | 8 | 14 |
| 12 | 75% Phos 71B:25% FR-2 | 14 | 14 | 8 | 13 |
| 13 | 100% Phosflex ® 71B | 16 | 16 | 12 | 12 |
| 14 | 50% NDP:50% | Not | Not | 8 | Not |
| | Pentabrom | determined | determined | | determined |
| 15 | 25% NDP:75% | Not | Not | 10 | Not |
| | Pentabrom | determined | determined | | determined |
| 16 | Fyrol | 6 | 6 | 12 | 12 |
| | PBR(75% pentabrom | | | | |
| | 25% Phosflex) | | | | |

*BDP/31L is an 80:20 blend of Fyrolflex BDP and Phosflex 31L

The above data (namely, the blends comprising the FR-2 product) demonstrate that for each of the tested blends, the actual amount of flame-retardant needed to pass the test was unexpectedly lower than would be predicted from a simple arithmetic averaging of the expected level from evaluation of the amount needed to pass the test for each of the neat materials forming the tested blend.

### EXAMPLES 17-20

### CAL 117 Data

The data in Table 2 illustrate the parts of flame-retardant needed to actually pass the TB 117 test in 1.0, 1.5 and 1.8 density foams. The numbers in parenthesis represent the theoretical predicted amounts calculated by averaging the expected level from evaluation of the neat materials.

TABLE 2
Passing FR's levels (theoretical level)

| | | | | | MVSS 302 | MVSS 302 |
|---|---|---|---|---|---|---|
| | | TB-117 | TB-117 | TB-117 | 1.5 pcf** | 1.8 pcf |
| | | 1.0 pcf | 1.5 pcf** | 1.8 pcf | parts | parts |
| Example | Product | parts | parts | parts | SENBR | SENBR |
| 17 | Fyrol FR-2 | 16 | 15 | 12 | 15 | 7 |
| 18 | NDP | 30 | 14 | 15 | 14 | 12 |
| 19 | NDP:FR-2 | 18 (23) | 8 (14.5) | 15 (13.5) | 8 (14.5) | 6 (9.5) |
| | 1:1 | | | | | |
| 20 | Fyrol PBR | 16 | 14 | 7 | 12 | 6 |

The above data illustrates that relative performanee of FR additives varies with foam densities as well as test method and that the described blends give unexpected synergism in most combinations.

From an analysis of the data for the MVSS 302 test and the CAL 117 test, a number of conclusions can be reached:

1. There appears to be an advantage in using the blend of phosphate esters and FR-2 (1:1 and 1:3) in a 1.5 density foam since FR-2 passes the MVSS302 test at 15 parts and the blends pass the test with less (8-12 parts). The same advantage is observed in the CAL 117 test where FR-2 passes at 15 parts and the NDP/FR-2 blend (1:1) passes at 8 parts.

2. In a 1.8 density foam, the 1:1 blend of NDP and FR-2 is as efficient as FR-2 in the MVSS302 test. This presents an advantage sinee NDP does not have the propensity to scorch of FR-2; by blending NDP and FR-2, one decreases the amount of scorch.

3. Although, some synergy was observed at 1.0 and 1.8 density foams in the CAL 117, the NDP/FR-2 blend requires a slightly higher level of flame-retardant than the neat FR-2. Here again, the main advantage of using the blend will come from its lower propensity to scorch.

The foregoing examples merely illustrate certain embodiments of the present invention and, for that reason should not be construed in a limiting sense. The scope of protection that is sought is set forth in the Claims that follow.

1. A polyurethane foam that contains an effective amount of a flame-retardant blend consisting essentially of: (a) a monomeric halogenated organic flame-retardant; and (b) a phosphate flame-retardant of the formula: 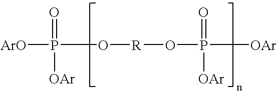
where Ar is an aryl or an alkaryl group, R is arylene or alkylene moiety and the average value of n is 0 to 5.

2. A foam as in claim 1 wherein the flame retardant (a) in the blend is an halogenated phosphate ester.

3. A foam as in claim 1 wherein the flame retardant (a) in the blend comprises a brominated organic compound.

4. A foam as in claim 1 wherein flame retardant (a) in the blend is a halogenated phosphate ester and is present at from about 25% to about 75% by weight of the blend.

5. A foam as in claim 1 wherein the flame retardant (a) in the blend is a brominated organic compound and is present at from about 25% to about 75% by weight of the blend.

6. A foam as in claim 1 wherein the phosphate ester flame retardant in the blend is of the formula: 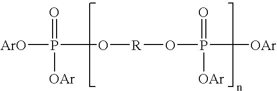
where Ar is phenyl or alkylphenyl group, R is resorcinyl, bisphenol A, neopentylene and the average value of n is 0 to 5.

7. A foam as in claim 2 wherein the phosphate ester flame retardant in the blend is of the formula: 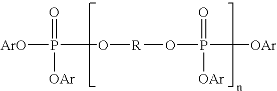
where Ar is phenyl or alkylphenyl group, R is resorcinyl, bisphenol A, neopentylene and the average value of n is 0 to 5.

8. A foam as in claim 3 wherein the phosphate ester flame retardant in the blend is of the formula: 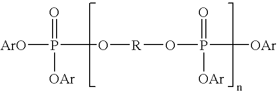
where Ar is phenyl or alkylphenyl group, R is resorcinyl, bisphenol A, neopentylene and the average value of n is 0 to 5.

9. A foam as in claim 4 wherein the phosphate ester flame retardant in the blend is of the formula: 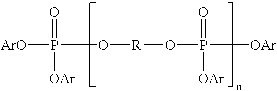
where Ar is phenyl or alkylphenyl group, R is resorcinyl, bisphenol A, neopentylene and the average value of n is 0 to 5.

10. A foam as in claim 5 wherein the phosphate ester flame retardant in the blend is of the formula: 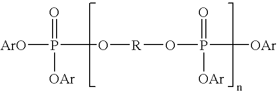
where Ar is phenyl or alkylphenyl group, R is resorcinyl, bisphenol A, neopentylene and the average value of n is 0 to 5.
